(19) United States
(12) Patent Application Publication
(10) Pub. No.: US 2012/0129386 A1
(43) Pub. Date: May 24, 2012

(54) CONNECTOR ASSEMBLY AND RECEIVING DEVICE THEREOF

(75) Inventor: ZHENG-HENG SUN, Tu-Cheng (TW)

(73) Assignee: HON HAI PRECISION INDUSTRY CO., LTD., Tu-Cheng (TW)

(21) Appl. No.: 12/960,530

(22) Filed: Dec. 5, 2010

(30) Foreign Application Priority Data
Nov. 19, 2010 (CN) 201010551179.1

(51) Int. Cl. H01R 13/60

(52) U.S. Cl. 439/540.1

(57) ABSTRACT

A connector assembly includes a receiving device, a first connector, and a second connector. The receiving device includes an accommodating portion, and a first and a second raised portions extending from a first side of the accommodating portion. The first and second raised portions each define a receiving space. The first connector is detachably mounted in the receiving space of the first raised portion. The second connector is detachably mounted in the receiving space of the second raised portion.

### BACKGROUND

1. Technical Field

The present disclosure relates to a connector assembly and a receiving device of the connector assembly.

2. Description of Related Art

With advances in computer technology, serial advanced technology attachment (SATA) connectors are more and more popularly used in disk drives and other storage peripherals. The SATA connectors include SATA power connectors and SATA signal connectors. In use, a SATA power connector and a SATA signal connector are integrated as an integrated connector fastened to an enclosure of a computer or server, to avoid the SATA power connectors and SATA signal connectors being plucked off when the disk drives are pulled from a front end of the enclosure. However, this kind of integrated connector is expensive and incapable of being disassembled. Should either the SATA power portion or the SATA signal portion of the integrated connector breakdown, the entire integrated connector must be replaced, which is costly.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a connector assembly.

FIG. 2 is similar to FIG. 1, but viewed from another perspective.

FIG. 3 is an assembled, isometric view of the connector assembly of FIG. 1.

FIG. 4 is an assembled, isometric view of the connector assembly of FIG. 2.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

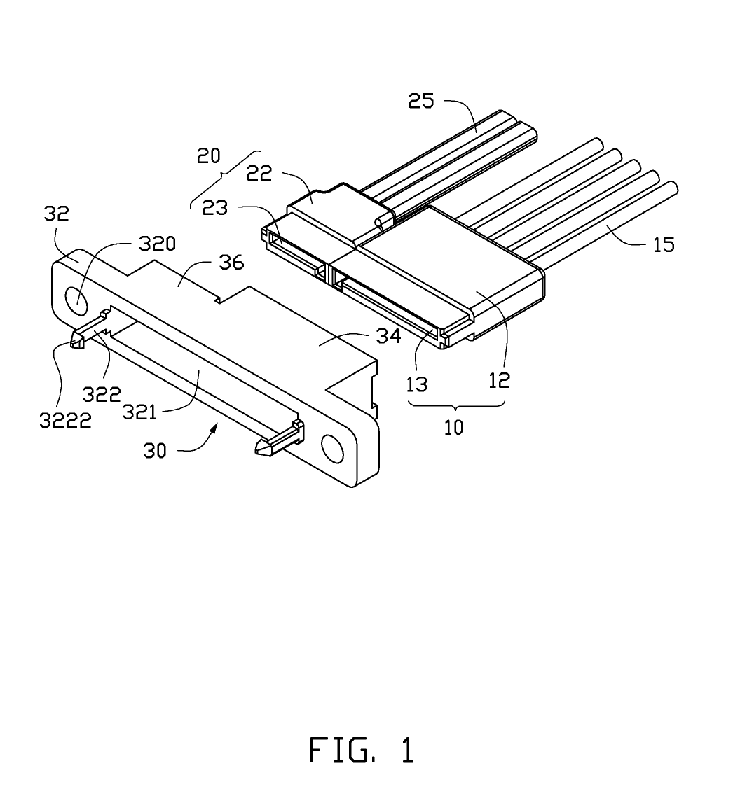

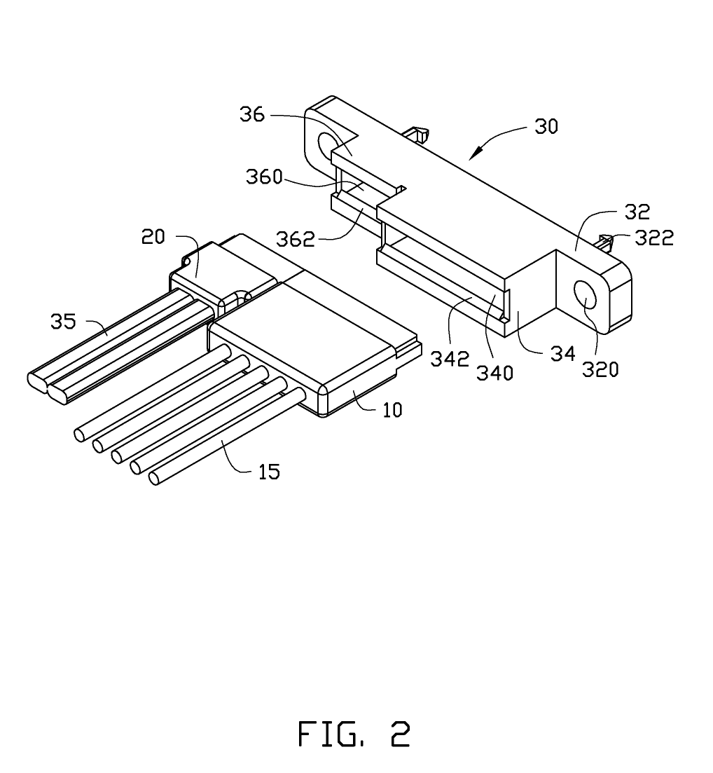

Referring to FIGS. 1 and 2, an exemplary embodiment of a connector assembly includes a first connector 10, a second connector 20, and a receiving device 30.

The first connector 10 is a serial advanced technology attachment (SATA) power connector. The second connector 20 is a SATA signal connector, used to transmit data between a SATA disk drive and a motherboard. In this embodiment, the motherboard can supply energy for the SATA disk drive through the first connector 10.

The first connector 10 includes an insulating main body 12, a conductive head 13 formed at a front end of the main body 12, and a plurality of SATA power cables 15 extending from a rear end of the main body 12. The main body 12 is substantially rectangular. The head 13 is electrically connected to the power cables 15.

The second connector 20 includes an insulating main body 22, a conductive head 23 formed at a front end of the main body 22, and a plurality of SATA signal cables 25 extending from a rear end of the main body 22. The main body 22 is substantially rectangular. The size of the main body 22 is less than the size of the main body 12 of the first connector 10. The head 23 is electrically connected to the signal cables 25.

The receiving device 30 includes a substantially rectangular accommodating portion 32, a first raised portion 34 protruding rearward from a first end of a rear side of the accommodating portion 32, and a second raised portion 36 protruding from a second end of the rear side of the accommodating portion 32. The receiving device 30 defines a substantially rectangular opening 321 in a front side of the accommodating portion 32. Two elastic latches 322 protrude forward from the front side of the accommodating portion 32, at opposite ends of the opening 321. A hook 3222 protrudes from a distal end of each latch 322, opposite to the accommodating portion 32. The accommodating portion 32 defines two through holes 320 in opposite ends of the accommodating portion 32 and at opposite ends of the latches 322. The size of the first raised portion 34 is larger than the size of the second raised portion 36. The first raised portion 34 defines a first receiving space 340 communicating with the opening 321 of the accommodating portion 32. The second raised portions 36 defines a second receiving space 360 communicating with the opening 321 of the accommodating portion 32. A substantially wedge-shaped block 342 protrudes up from a bottom side bounding the receiving space 340. A substantially wedge-shaped block 362 protrudes up from a bottom side bounding the receiving space 360.

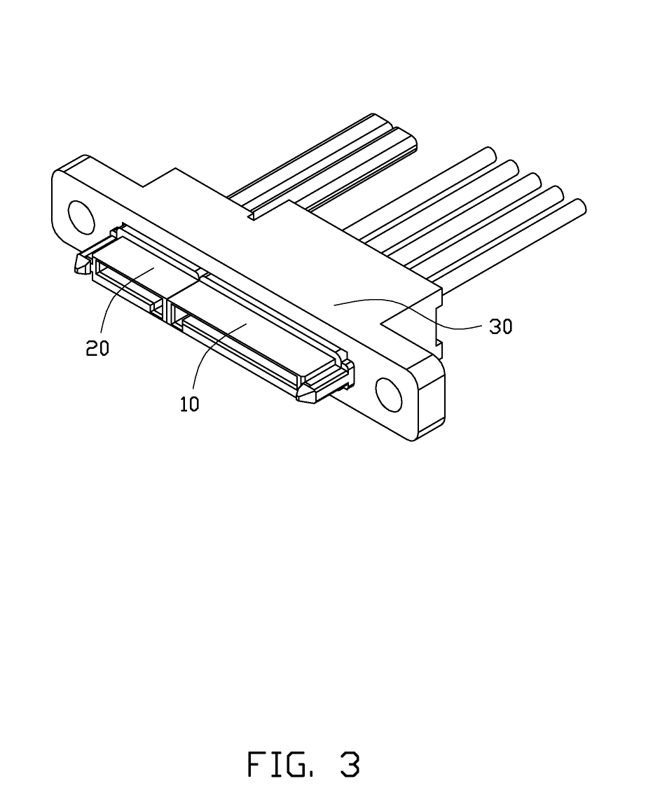

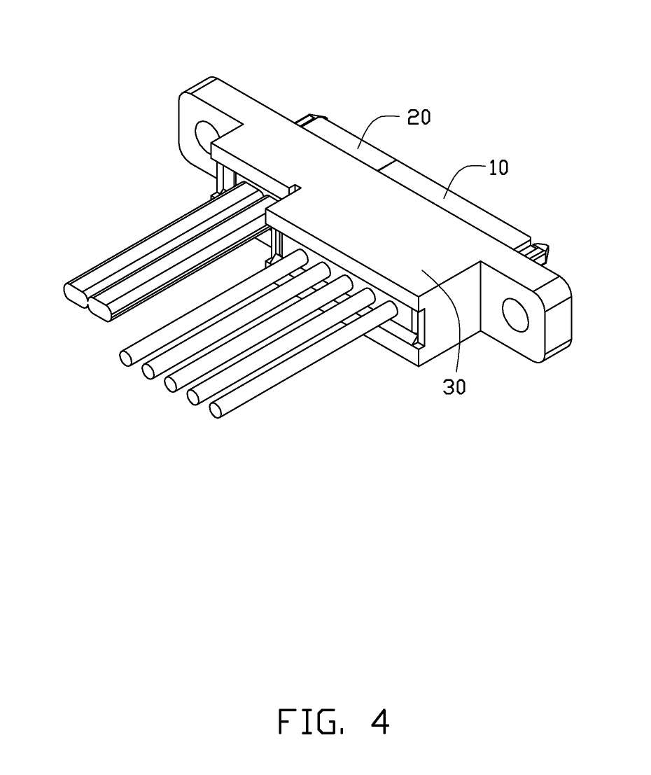

Referring to FIGS. 3 and 4, in assembly, the latches 322 are deformed away from each other, and the main bodies 12 and 22 of the first and second connectors 10 and 20 together with the power cables 15 and the signal cables 25 extend through the opening 321 of the accommodating portion 32, with the main bodies 12 and 22 received in the receiving spaces 340 and 360 and rear sides of the main bodies 12 and 22 blocked by the blocks 342 and 362. The cables 15 and 25 pass through the receiving spaces 340 and 360. The latches 322 are released to be restored, with the hooks 3222 blocking front sides of the heads 13 and 23 and opposite ends of the main bodies 12, 22 resisting against the corresponding block 342, 362 and the corresponding protrusion 3222. The blocks 342 and 362 of the first and second raised portions 34 and 36 block rear sides of the main bodies 12 and 22 of the first and second connectors 10 and 20, respectively.

In use, the first and second connectors 10 and 20 are electrically connected to the disk drive by the heads 13 and 23. Two fasteners, such as screws, extend through the through holes 320 of the receiving device 30 to fasten the connector assembly to an enclosure of a computer or a server.

In other embodiments, the opening 31 of the accommodating portion 32 can be replaced by two adjacent openings, the first receiving space 340 of the first raised portion 34 is communicated with one of openings, and the second receiving space 360 of the second raised portion 36 is communicated with the other opening.

If either of the first connector 10 and second connector 20 breakdown, the corresponding latch 322 is deformed away from the other latch 322, and the broken connector is readily removed and replaced by a new connector, which is very convenient and saves money over replacing the whole connector assembly.

It is to be understood, however, that even though numerous characteristics and advantages of the embodiments have been set forth in the foregoing description, together with details of the structure and function of the embodiments, the present disclosure is illustrative only, and changes may be made in details, especially in matters of shape, size, and arrangement of parts within the principles of the embodiments to the full extent indicated by the broad general meaning of the terms in which the appended claims are expressed.

1. A connector assembly comprising:
a receiving device comprising an accommodating portion, and a first and a second raised portions extending from a rear side of the accommodating portion, wherein the first and second raised portions each define a receiving space;
a first connector detachably mounted in the receiving space of the first raised portion; and
a second connector detachably mounted in the receiving space of the second raised portion.

2. The connector assembly of claim 1, wherein the accommodating portion defines an opening in a front side opposite to the rear side, the receiving spaces of the first and second raised portions communicate with the opening of the accommodating portion.

3. The connector assembly of claim 2, wherein two elastic latches protrude forward from the accommodating portion and at opposite ends of the opening, the first and second raised portions each form a block on a bottom side bounding the corresponding receiving space, front and rear sides of the first and second connectors resist against the latches and the blocks.

4. The connector assembly of claim 3, wherein a hook protrudes from a distal end of each latch to block the front side of a corresponding one of the first and second connectors.

5. The connector assembly of claim 3, wherein the blocks are substantially wedge-shaped.

6. A receiving device used to receive a first and a second connectors, the receiving device comprising:
an accommodating portion defining an opening in a first side of the accommodating portion;
a first raised portion extending from a second side of the accommodating portion opposite to the first side; and
a second raised portion extending from the second side of the accommodating portion;
wherein the first and second raised portions each define a receiving space communicating with the opening, the first and second connectors extend through the opening to be detachably mounted in the corresponding receiving spaces of the first and second raised portions.

7. The receiving device of claim 6, wherein two elastic latches protrude from the accommodating portion and at opposite ends of the opening, the first and second raised portions each forms a block on a bottom side bounding the corresponding receiving space, the first and second connectors are restricted between the latches and the blocks.

8. The receiving device of claim 7, wherein a hook protrudes from a distal end of each latch to resist against the corresponding one of the first and second connectors.

9. The receiving device of claim 7, wherein the blocks are substantially wedge-shaped.
